(19) United States
(12) Patent Application Publication
(10) Pub. No.: US 2018/0081953 A1
(43) Pub. Date: Mar. 22, 2018

(54) SYSTEM, COMPUTER-IMPLEMENTED METHOD, AND COMPUTER PROGRAM FOR IMPROVING ACCESS TO AND USEFULNESS OF DATA FOR BUSINESS INTELLIGENCE

(71) Applicant: idea5, LLC, Omaha, KS (US)

(72) Inventor: WILLIAM FRANCIS GOEDKEN, OMAHA, NE (US)

(73) Assignee: idea5, LLC, OMAHA, NE (US)

(21) Appl. No.: 15/272,182

(22) Filed: Sep. 21, 2016

(51) Int. Cl. G06F 17/30; G06Q 10/06

(52) U.S. Cl. CPC G06F 17/30563; G06F 17/30418; G06F 17/30421; G06F 17/30589; G06Q 10/063; G06F 17/30241; G06F 17/30303; G06F 17/30371; G06F 17/30548

(57) ABSTRACT

A system, computer-implemented method, and computer program for enhancing business intelligence and peer analysis by improving access to and analysis of data and generation and presentation of results for a remote user. A data transporter assembles and normalizes data from different sources. The data is stored in a data mart having multiple data stores include curated and metadata stores. An API receives a request for a time series and/or geospatial dataset with attributes indicating levels of aggregation and granularity, interacts with the metadata to generate a corresponding SQL query, executes the SQL against the curated data, and communicates the resulting dataset to a BI software application in an open standard data format. The data mart may host the curated data in a star schema having a plurality of dimensions, the data transporter component may include a key management controller, and the data transporter may also interact with the metadata.

### FIELD

The present invention relates to systems, methods, and computer programs for improving research, and, more particularly, to a system, computer-implemented method, and computer program for enhancing business intelligence and peer analysis by improving access to and analysis of data and generation and presentation of results.

### BACKGROUND

It is often desirable to search for and analyze information about a subject of interest. Commonly available search engines often return voluminous amounts of information, some of which may be redundant, irrelevant, or otherwise undesired or not useful. Even returned information that is desired and useful may be incompatibly formatted or coded or otherwise impractical or inefficient to use.

In business, for example, access to and analysis of the most current information is necessary in order to prosper. Understanding and making decisions regarding such issues as attracting new customers, expanding market presence, locating branches, responding to competition, and adapting to changing demographic and economic trends requires access to data. While much of the relevant data is publicly available, manually collecting it from multiple disparate sources, adapting and combining the different data streams to work together, analyzing it, and reporting it in the form of actionable information can be extremely time-consuming and expensive, and a failure at any point (e.g., missing an important source, improperly adapting or analyzing the data, or poorly presenting the resulting information) can lead to misunderstandings and incorrect decisions.

Business intelligence (BI) software applications, such as Microsoft SQL Server Reporting Services (SSRS), Tableau, Qlik, Birst, Pentaho, and Tibco, attempt to make such data more useful. However, existing BI software suffers from several limitations and other disadvantages. For example, existing BI software typically requires users to download and install software locally, which can require overcoming significant compatibility and other technical obstacles. Further, existing BI software typically requires users to provide their own data, which, as discussed, can be extremely time-consuming, expensive, and fraught with risks. Additionally, existing BI software typically requires users to develop their own research templates and report templates, which can be time-consuming, requires the ability to write software code, and which may not reflect the best practices of the particular industry.

This background discussion is intended to provide information related to the present invention which is not necessarily prior art.

### SUMMARY

Embodiments of the present invention solve the above-described and other problems and limitations by providing a system, method, and computer program for enhancing business intelligence and peer analysis by improving access to and analysis of data and generation and presentation of results.

In an exemplary embodiment of the present invention, a system is provided for improving access to and usefulness of data for business intelligence by a remote user of a business intelligence software application in a particular industry. The system may broadly comprise the following. An electronic processing element may implement a data transporter component configured to assemble data relevant to the particular industry from a plurality of different data sources and to normalize the data. An electronic memory element may house a data mart component configured to receive and store the normalized data from the data transporter component, with the data mart having a plurality of data stores including a raw data store, a staged data store, a curated data store, and a metadata store. The processing element may further implement an application programming interface component configured to receive a request from the remote user for a high level time series and/or geospatial dataset with attributes indicating a level of aggregation and a level of granularity, interact with the metadata store to generate a corresponding structured query language query, and execute the structured query language query against the curated data store, and communicate the resulting dataset to the business intelligence software application in an open standard data format.

Various implementations of the foregoing embodiment may include any one or more of the following additional features. The particular industry may be a financial services industry, and the data may include demographics data, economic data, financial services data, and geographic data, and the data mart component supports times series analysis and geospatial analysis of the data. The data transporter component may be an extraction, transformation, and loading transporter. The data transporter component may be configured to normalize the data by performing a series of transformation, validation, and cleansing procedures in order to homogenize semantics, constraints, formats, and coding of the data from the different data sources. The data mart component may host the curated data in a star schema having multiple dimensions. The data transporter component may be configured to validate and geocode address data in order to support a geography dimension. The data transporter component may include a key management controller configured to submit a unique internal key for each dimension of the multiple dimensions. The metadata store may include declarations of all of a plurality of data mart objects, data mart object relationships, and data mart object properties, and a set of taxonomy and inventory details, including storage locations, of curated data in the curated data store. The data transporter component may be configured to interact with the metadata store to identify a plurality of specific objects in each data store, and to identify a status information specific to the assembly of the data. The application programming interface component may be further configured to provide an open standard data access via web service endpoints to the curated data store for the business intelligence software application.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a depiction of an embodiment of an exemplary database component of a system for enhancing business intelligence and peer analysis by improving access to and analysis of data;

FIG. 2 is a depiction of an embodiment of an exemplary business intelligence software application component of the system for enhancing business intelligence and peer analysis by improving generation and presentation of research results;

FIG. 3 is a flowchart of an embodiment of an exemplary computer-implemented method characterization of the functionalities of the database component and the business intelligence software application component;

FIG. 4 is a depiction of a portion of an exemplary report including a table containing a comparison of demographics across a current market and two proposed markets;

FIG. 5 is a depiction of a portion of an exemplary report including a bulleted presentation setting forth observations based on an analysis of a particular market;

FIG. 6 is a depiction of a portion of an exemplary report including a table showing population trends over time for a particular market;

FIG. 7 is a depiction of a portion of an exemplary report including a map and a table showing a demographic summary for a particular population;

FIG. 8 is a depiction of a portion of an exemplary report including a map and a table describing individuals moving into and home values in a particular area;

FIG. 9 is a depiction of a portion of an exemplary report including a map and a table describing aspects of households in a particular area;

FIG. 10 is a depiction of a portion of an exemplary report including a map and a table describing housing trends in a particular area;

FIG. 11 is a depiction of a portion of an exemplary report including a first map showing numbers of employed for a particular area, and a second map showing numbers of retail jobs for the particular area;

FIG. 12 is a depiction of a portion of an exemplary report including a map showing branch location for a particular area, a first table describing the branches, and a second table describing aspects of the branches;

FIG. 13 is a depiction of a portion of an exemplary report including a table summarizing information for a plurality of individual institutions;

FIG. 14 is a depiction of a portion of an exemplary report including a table summarizing information for a plurality of individual institutions;

FIG. 15 is a depiction of a portion of an exemplary report including a chart describing market shares for a plurality of individual institutions; and

FIG. 16 is a depiction of a portion of an exemplary report including a first map showing income information for a particular area for regulatory purposes, and a second map showing minority information for the particular area for regulatory purposes.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

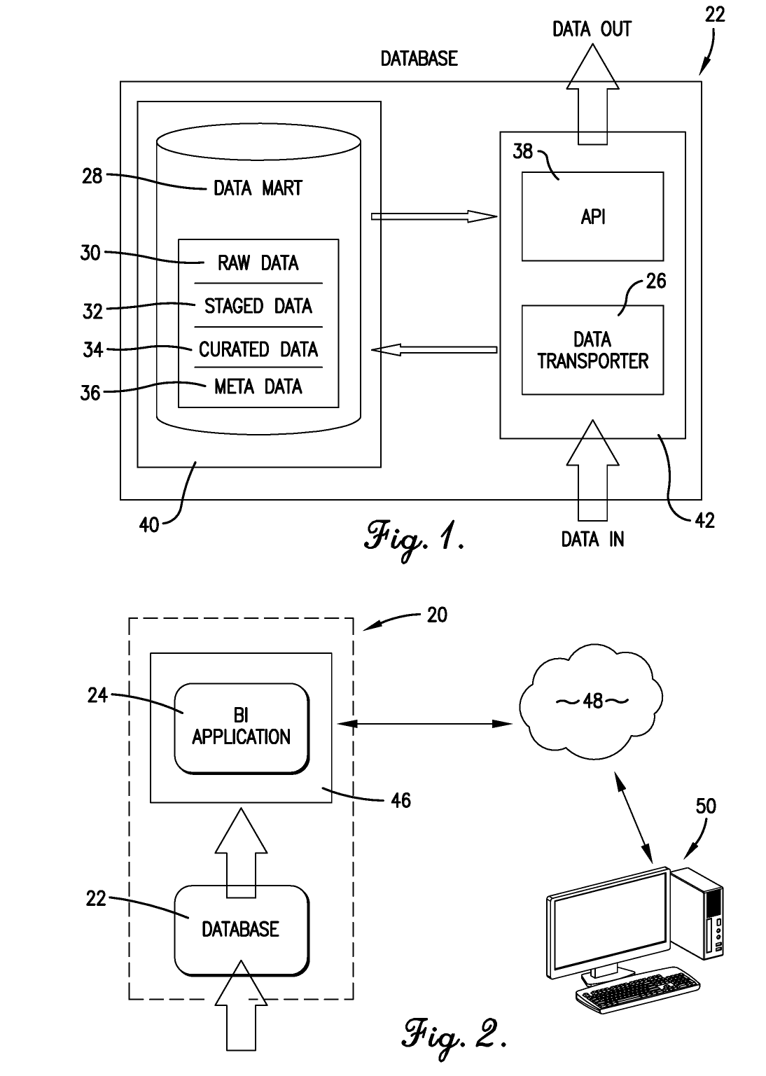

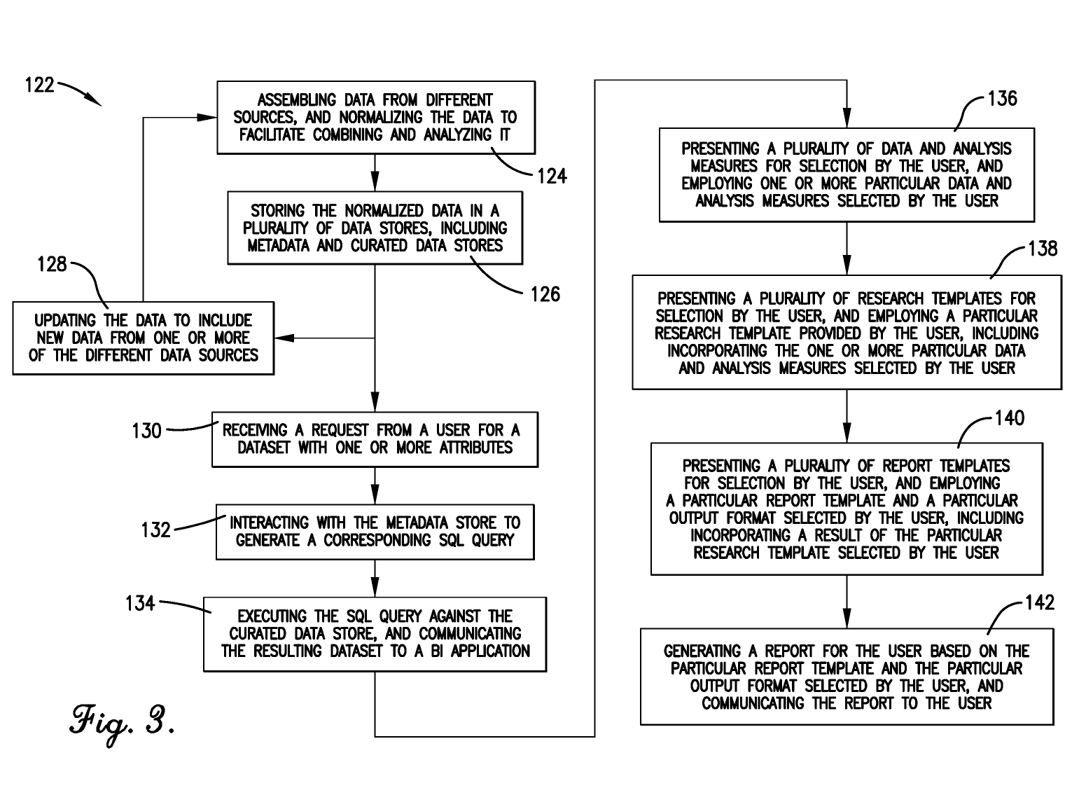

Broadly characterized, embodiments of the present invention provide a system, computer-implemented method, and computer program for enhancing business intelligence and peer analysis by improving access to and analysis of data and generation and presentation of results. The system 20 may broadly include a database component 22, an exemplary embodiment of which is shown in FIGS. 1 and 3 and described below, and a BI software application component 24, an exemplary embodiment of which is shown in FIGS. 2 and 3 and described below. In various embodiments of the overall system, the database component 22 shown and described herein may be used with substantially any suitable BI software and is not limited to use with the BI software application component 24, and conversely, the BI software application component 24 may be used with substantially any suitable database and is not limited to use with the database component 22.

### I. Database Component 22

Broadly characterized, embodiments of the database component 22 provide a cloud-based central database, or “Data Warehouse”, for scalable, highly available, and read-optimized use by a BI software application, such as the BI software application 24 described below, to facilitate better access to and usability of BI-relevant information for a remote user in a particular industry. Embodiments provide end-to-end data collection processing of an identified data input stream, from raw data format to curated data format, stored in a multi-dimensional Data Mart schema of the Data Warehouse, and a data output stream for use by the BI application 24. The data input streams may include public, semi-private, and/or private (e.g., proprietary or internal) data, and the stored data may be periodically or continuously updated.

Referring to FIGS. 1, 2, and 3, exemplary embodiments of the Data Warehouse 22 are shown characterized as part of a system and as part of a computer-implemented method 122. The Data Warehouse 22 may broadly include a multi-layered framework comprising a Data Transporter component 26; a Data Mart 28 component including a plurality of data tiers, such as a Raw Data store 30, a Staged Data store 32, a Curated Data store 34, and a Metadata store 36; and an Application Programming Interface (API) component 38. An exemplary system environment for implementing the Data Warehouse 22 may broadly comprise an electronic memory element 40 configured to house the Data Mart 28, and an electronic processing element 42 configured to implement the Data Transporter component 26 and the API component 38.

The Data Transporter component 26, which may be an extraction, transformation, and loading (ETL) transporter, may assemble the data from multiple data sources, and cleanse, conform, and otherwise normalize the data, as shown in 124, and store the data in the Data Mart 28, as shown in 126. Normalizing data from different data sources allows them to work substantially seamlessly together, including allowing for aggregating different date granularities or geographic granularities for the purpose of analysis. For example, data that is provided at a census-tract level can be aggregated to a state or regional level for analysis or for use alongside other data that is only available at a state or regional level. The Data Transporter component 26 may further update the data stored in the Data Warehouse 22 to include new data from one or more of the sources, as shown in 128. Updating the data may occur periodically at fixed or variable intervals or continuously.

In more detail, the Data Transporter component 26 may be responsible for scheduled data import processing (ETL processes), acquiring data from different source systems, and applying a series of transformation, validation, and cleansing procedures in order to evolve from heterogenous semantics, constraints, formats, and coding to a homogenous result stored in the Data Mart 28. For example, address data may be validated and geocoded before they are stored in the Data Mart 28 to support the advanced geography dimension. Further, an internal Key Management controller may submit unique internal keys for dimensional elements to achieve independence from diverse data source taxonomies and ensure key consistency and integrity.

The Data Mart model may be based on a dimensional design concept, and may host the curated data content in a multidimensional star schema. In embodiments, the content of the Data Mart 28 may include thirty dimensions with over eighty conformed derived-dimensions and over one hundred and twenty fact tables, highly specialized for data analytics specific to the one or more particular industries (e.g., the financial services industry). The Data Mart component 28 may include content categories such as a Demographics Data Mart (population, household, housing, employment, industry), an Economics Data Mart (GDP, Treasury rate, unemployment, monetary, inflation, and prices), a Financial Services Data Mart (FDIC, NCUA, HMDA, and market rates), and a Geography Data Mart (GIS, geocoding, spatial analysis, market footprints, assessment areas). The architecture of the Data Warehouse 22 may allow for scaling out the curated data tier for additional industry specific Data Marts. The architecture of the Data Mart 28 may support times series analysis as well as geospatial analysis required for market, competitive, and/or regulatory intelligence. Both dimensions and fact measures may contain spatial as well as time attributes in order to meet these requirements. Geospatial awareness may be realized by an advanced geography dimension based on the Census geography hierarchy: Census Block, Census Block Group, Census Tract, County, MSA, State, Census region, and Country.

More broadly, the natures and identities of the different data sources may depend on the type of industry or research being served. For example, if the financial services industry is being served, then exemplary data sources may include any one or more of American Community Survey, Board of Governors of the Federal Reserve System, Federal Deposit Insurance Corporation, Federal Financial Institutions Examination Council, FHLB—Des Moines, Home Mortgage Disclosure Act, National Credit Union Administration, RateWatch, Uniform Bank Performance Report, U.S. Bureau of Labor Statistics, U.S. Bureau of Economic Analysis, and U.S. Census Bureau.

Similarly, the natures of the different data may also depend on the type of industry or research being served. For example, if the financial services industry is being served, then exemplary data may include any one or more of financial institution data (e.g., FDIC Bank Reports and Key Metrics, Bank Service Offerings, Uniform Bank Performance Ratios (UBPR), Bank & Credit Union Branch Locations, Credit Union ATM Locations, Bank Branch Deposits, Branch Statistics, NCUA Credit Union Call Reports and Key Metrics, Bank Service Offerings, Uniform Bank Performance Ratios (UBPR), Bank Branch Locations, and Bank Branch Deposits), Economic data (e.g., Local Area Labor Statistics, National Labor Statistics U3 and U6, GDP: National, State, MSA, Personal Income: National and Local, Consumer Price Indices, Producer Price Indices, Building Permits by State, Building Permits by MSA, Housing Units: Starts, Housing Units: Under Construction, Housing Units: Completed, Houses for Sale, Houses Sold, Money Supply, and State Employment and Wages by Industry), rate data (e.g., Treasury, Fed Funds and Prime Rates, FHLB—Des Moines Advance Rates, Swap Rates, RateWatch Offering Rates—Loans, and RateWatch Offering Rates—Deposits), and census data (e.g., Population by Sex and Age, Housing Units by Occupancy Status, Occupied Housing Units by Tenure and Age of Householder, Occupied Housing Units by Tenure and Household Size, Occupied Housing Units by Mortgage Status, Vacant Housing Units, Total Population/Population Density, Population by Sex and Age, Population by Race and Hispanicity, Education Attainment by Sex and Race, Education Attainment by Sex and Hispanicity, Occupied Housing Units by Tenure and Age of Householder, Household Income by Type, and Home Value/Price Asked). More broadly, the BI application 24 may provide access to data on a wide range of subjects.

The metadata store model may include declarations of all Data Warehouse objects, object relationships, and object properties such as indexes and filters. The Metadata store 36 may also provide the taxonomy and inventory details, including storage location, of the data content of the Data Mart 28. Hence the exact fact table data cell for a specific measure in the Data Mart 28 can be retrieved from the Metadata store 36. This may be leveraged by the API component 38 for automated Data Mart navigation and query generation. Also, the Data Transporter component 26 may interact with the Metadata store 36 to identify data collection specific objects in each data tier as well as data collection specific status information.

Defining isolated data stores (Raw 30, Staged 32, and Curated 34) to manage data at different stages in the Data Warehouse migration process provides a clean Data Warehouse implementation and supports data consistency and integrity. The addition of the Metadata store 36 to the data tier framework enables a high level automation for data migration and data consumption processes, and further, it enables scalability at the curated data tier level. In more detail, the layered design of the Data Warehouse 22 with the Metadata store 36 that defines each object and its relationships enable high scalability at the curated data tier level. The Metadata store's data model allows data content taxonomies and declarations for the Data Mart 28. Additional industry specific Data Marts can be added to the Data Warehouse framework with the data content and data structure defined in the Metadata store.

The API component 38 may be configured to receive and process high level time series and/or geospatial data set requests from the BI application 24 with attributes indicating level of aggregation (e.g., sum, average, minimum, maximum) and level of granularity (e.g., daily or monthly), as shown in 130. After parsing and analyzing the request, the API component 38 may interact with the Metadata store 36 to generate the corresponding structured query language (SQL) query, as shown in 132. The SQL query may then be executed against the Data Mart 28, particularly the Curated Data store 34, and the resulting data set may then be routed back to the BI application 24 in an open standard data format, as shown in 134. In more detail, the API component 38 may provide an open standard data access (OData) via RESTful web service endpoints to the content of the Curated Data store 34 in the Data Mart 28 for data consuming applications like the BI application 24 or other BI clients and platforms like Tableau and Power BI. The API component 38 may interact with the Metadata store 36 in order to generate query code for on-demand retrieval of data sets from the Data Mart 28.

The electronic memory element 40 may house the Data Mart 28. The memory element 40 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The electronic processing element 42 may implement the Data Transporter component 26 and the API component 38. As such, the processing element 42 may be substantially any suitable microcontroller, microprocessor, processor, computing device, or the like.

The exemplary system environment may further include an electronic communications network 48 which may facilitate electronic the communication of requests and results between the system 20 and the remote user. The communications network 48 may use substantially any standard or technology (e.g., GSM, CDMA, TDMA, WCDMA, LTE, EDGE, OFDM, GPRS, EV-DO, UWB, WiFi, IEEE 802 including Ethernet, WiMAX, and/or others).

Additionally or alternatively, the Data Warehouse 22 may include any one or more of the following features. The Data Warehouse 22 may include a variety of components, such as a Reporting Framework component, a Dynamic Data Warehouse Query component, a Clustering and Segmentation component, a Statistical Algorithm component, and a Data Mining component. The Data Warehouse 22 may include Analytic Intelligence components, such as a Strategy component, a Compliance component, a Market component, a Competition component, and a Peer component. A User Interface may allow a user to select a variety of tasks, including Board of directors, Competition and Peers, M and A research, Market Analysis, Regulatory support, Research and Institution, and Strategic Planning); and to select a variety of topics, including Best Practice, Case Studies, Census, Economic Material, Industry Analysis, and Interesting Stuff; and to select an output format, such as Chart, Map, and Table.

Exemplary applications for and variations of the Data Warehouse 22 may include the following. The Data Mart 28 may be tailored to serve business intelligence analytics for the Financial Services industry. The content of the Curated Data store 34 may support applications for market analysis, peer-to-peer analysis, competitive analysis, regulatory analysis, merger and acquisition analysis, and more. The API component 38 may be configured to allow BI clients with open standard data discovery adapters to connect to the Data Warehouse 22 and download data sets from the Data Mart 28 in a managed and monetized fashion. Features such as customer authentication and data transfer throttling data transfer monetization may be added to the API component 38 to enable this type of application. This may allow users to target specific data sets in the Data Mart 28, limited by time and geography, and download to their specific business intelligence tool (e.g., Tableau, Excel, Power BI) or BI platform. Additional Data Marts may be added for specific industries (e.g., insurance), which is facilitated by the flexible design of the Data Warehouse 22. Some of the basic objects of the Data Mart 28 to support time-series analysis and geospatial analysis may be shared among different Data Marts, such as time and geography dimensions.

It will be appreciated that some or all of the components or their functionalities of the database component 22 may be additionally or alternatively characterized or claimed in terms of a system, a computer-implemented method, or a computer program stored on a non-transitory computer-readable medium.

### II. BI Software Application Component 24

Broadly characterized, embodiments of the BI software application 24 provide a cloud-based BI tool for researching, analysing, and presenting data accessed from a database, such as the database component 22 described above, in order to facilitate the efficient completion of business intelligence and competitive analytics tasks, projects, and reports by a remote user in a particular industry. Further, these tasks, projects, and reports can be quickly and easily repeated (e.g., daily, weekly, monthly, quarterly, annually) to include any new data added to the Data Warehouse 22.

The data may include public, semi-private, and/or private (e.g., proprietary or internal) data, and may be stored in and accessed from Data Warehouse 22. Thus, embodiments of the BI application 24 may come ready to use with the Data Warehouse 22 already connected to the application 24. Most existing BI software assumes that users will provide the necessary data. Further, not only may the data be provided with the BI application 24, but the data may actually inform the behavior of the BI application 24, including guiding users to select from available options based on the data that the users have chosen to explore, as described below.

Referring to FIGS. 2 and 3, exemplary embodiments of the BI application 24 are shown characterized as part of the system 20 and as part of the computer-implemented method 122 for enhancing business intelligence and peer analysis by improving access to and analysis of data and generation and presentation of results.

Because the application 24 is cloud-based, the remote user is not required to install any software locally, unlike users of most existing BI software. Instead, the remote user may access the BI application 24 via the electronic communications network 48 described above using substantially any suitable electronic device 50. In more detail, the BI application 24 may run entirely within a web browser on the remote user's device 50, which may be a desktop, laptop, or tablet computer and the like using substantially any suitable operating systems, such as Microsoft Windows and/or Apple's OSX and IOS operating systems.

The computer-implemented method 122 may broadly include the following steps. The steps may be implemented by an electronic processing element 46, which may or may not be the electronic processing element 42 described above. Standard and custom data and analysis measures, such as ratios, trend analysis, and unique analytics, may be created for and presented to the user for consideration and selection, and the selected one or more particular data and analysis measures may be employed, as shown in 136. The measures may reflect the needs and/or desires of users, such as users in particular industries and/or users researching particular subjects.

Selectable pre-made research templates for a wide variety of relevant subject matters and best practices may be presented to the user for consideration and selection, and the selected particular research template may be employed, as shown in 138. Additionally or alternatively, the user may be allowed to create their own research templates or to perform open-ended research. The pre-made research templates may be grouped by subject matter to facilitate selection. Most existing BI software requires users to develop their own research templates. Further, the research templates may be customized to a particular institution, industry, or research subject, possibly including being pre-filled with a particular institution's data. For example, research templates for the financial services industry may include Asset/Liability Compliance committee (ALCO), regulatory and compliance, positioning of Millennials in markets, demographic trends by geographic area, growth rates of employment by types of employer, peer comparisons and top performers, unemployment by geographic area, and mortgage loan origination trends. Relatedly, the research templates may be enhanced by the ability of the BI application 24 to substantially automatically customize the content of reports based on the profile and preferences of individual users, as well as dynamic variables, so that each user receives content that is specific to that user.

Selectable pre-made report templates and selectable pre-made presentation-ready output formats for a wide variety of relevant subject matters may be presented to the user for consideration and selection, and the selected particular report template and output format may be employed, as shown in 140. Additionally or alternatively, users may be allowed to create their own report templates, either without assistance or by selecting reporting options from menus. Exemplary output formats may include charts, maps, tables, and/or other useful formats. The pre-made report templates and output formats may be grouped by subject matter to facilitate selection. Most existing BI software requires users to develop their own report templates, which may require software coding. Further, the report templates may be customized to a particular institution, industry, or research subject, possibly including being pre-filled with a particular institution's data.

A report may be substantially automatically generated by for the user based on the selected one or more particular data and analysis measures, the selected particular research template, and the selected particular report template and output formats, as shown in 142. For example, once a user selects a data measure from the available data measures, the BI application 24 may substantially automatically create a report for the selected data measure without requiring the user to define other or all aspects of the report. Options for the report may be pre-selected by the BI application 24 based on the selected data measure and the current user context. These options may include date, chart type, color(s), and vertical and horizontal axis settings. The default options may be the options that would most commonly be selected by a user, but the user may be allowed to selecting different options from the BI application's menus. The BI application 24 may prevent the user from choosing incompatible options. As the user adds content to the report, the BI application's menus may substantially automatically filter the selectable options that are presented to the user so that only compatible options are available for selection. For example, if a user creates a report with “County” as a report axis, then the BI application 24 may only allow the user to choose from data measures that are able to be charted by County. More broadly, the BI application may 24 be aware of the valid ways by which a data measure may be aggregated or categorized, and may only present valid options to the user for the way in which the data measure is to be aggregated into a report or used in the “Category” axis of the report.

In addition to being a BI tool, the BI application 24 may also be used as a peer analysis tool. Existing peer analysis tools for financial institutions include Callahan's Peer-to-Peer software and SNL Financial. As a peer analysis tool, the Data Warehouse 22 accessed by the BI application 24 may provide extensive data about peer institutions, which may be narrowly or widely defined. A wide definition allows users of the BI application 24 to be informed about the entire industry, not just about other institutions in their own classification. For example, user in the financial industry, both banks and credit unions as well as other relevant financial institutions may be included in the peer analysis, and the Data Warehouse 22 accessed by the BI application 24 may contain financial data such as bank and credit union call report data, mortgage data, and branch location data. In addition, the Data Warehouse 22 may also contain a large amount of economic and market data as well as United States census data, which allows users to do more than just peer and competitor analysis. Further, in addition to allowing users to compare across financial institutions for a given point in time, the BI application 24 may also allow users to conduct time-series analysis using many years of available historical data.

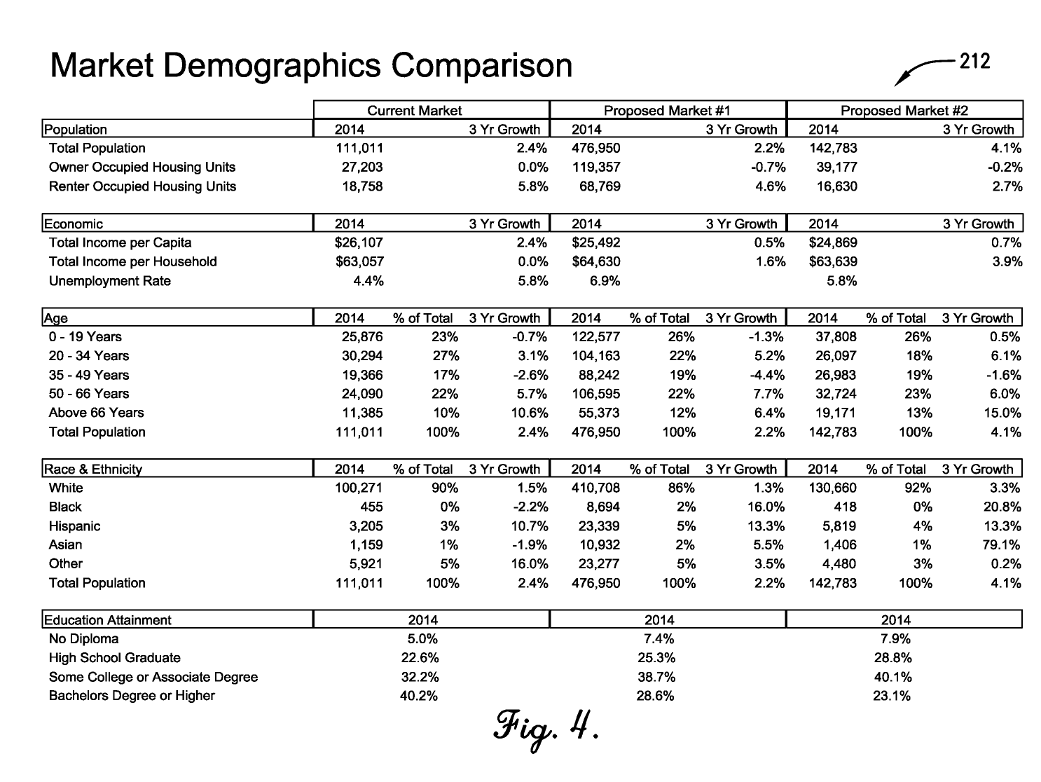

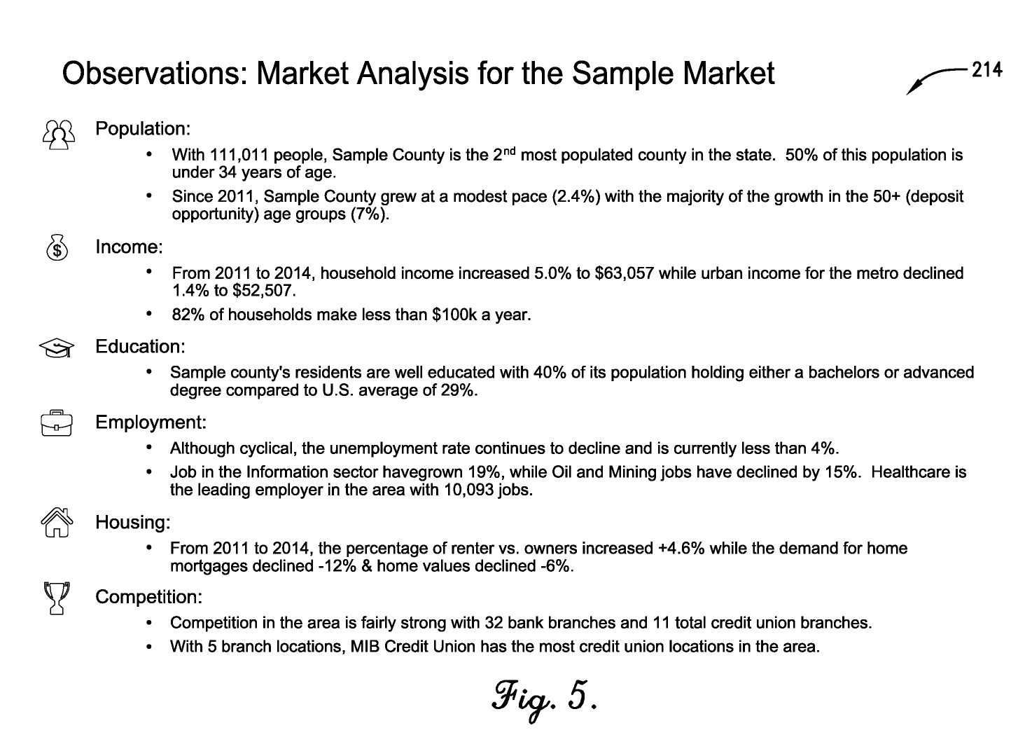

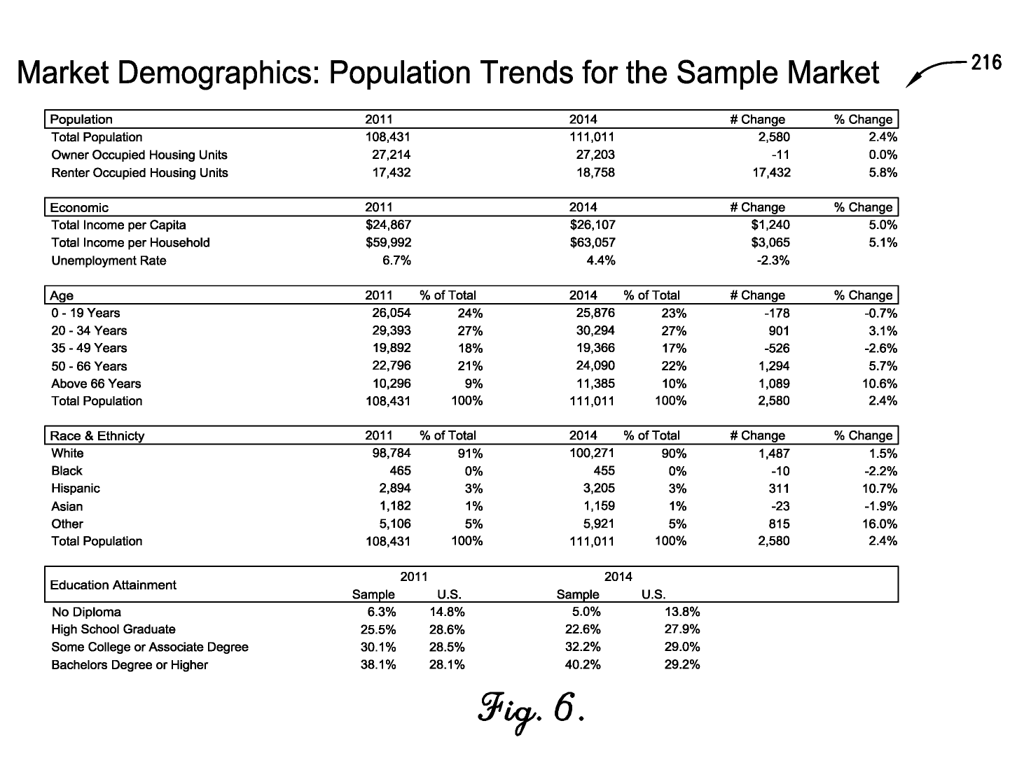

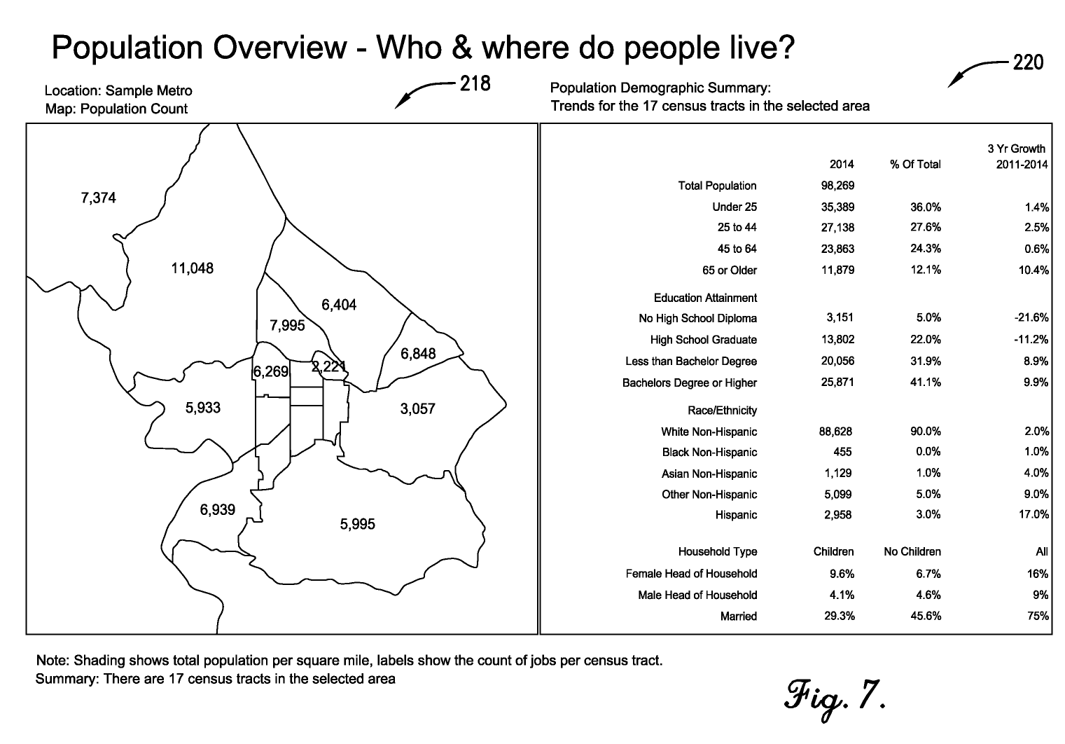

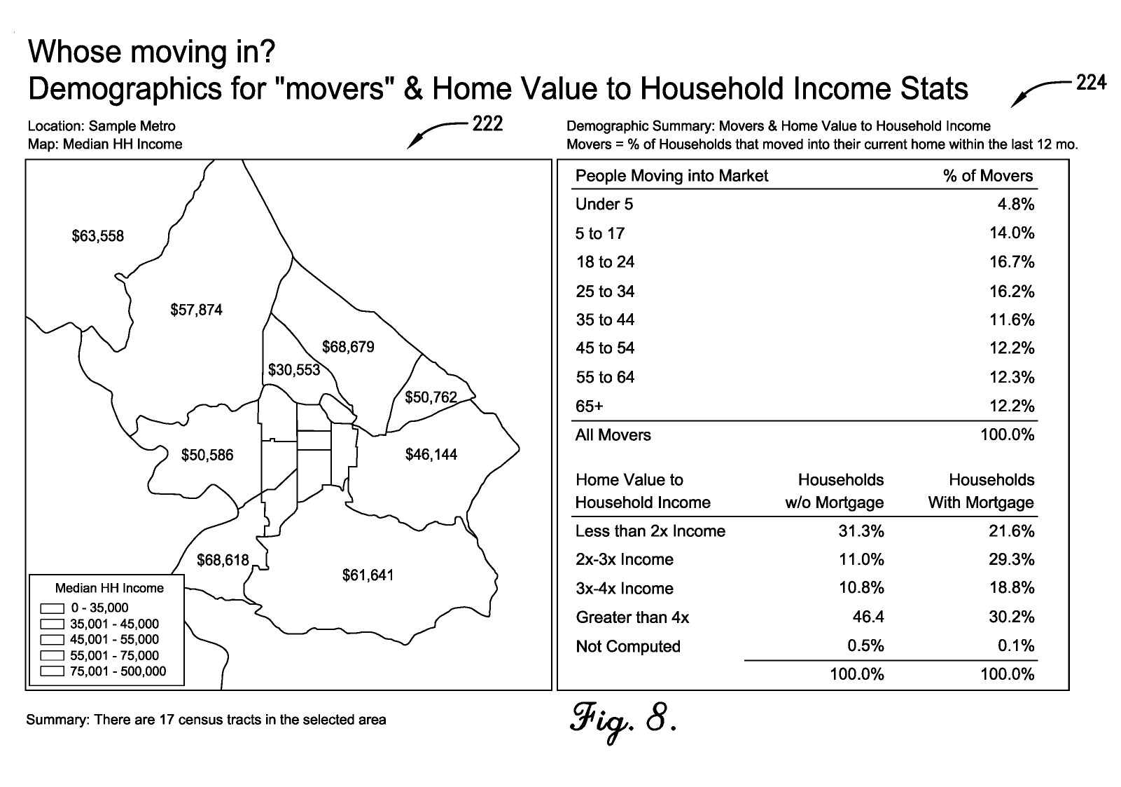

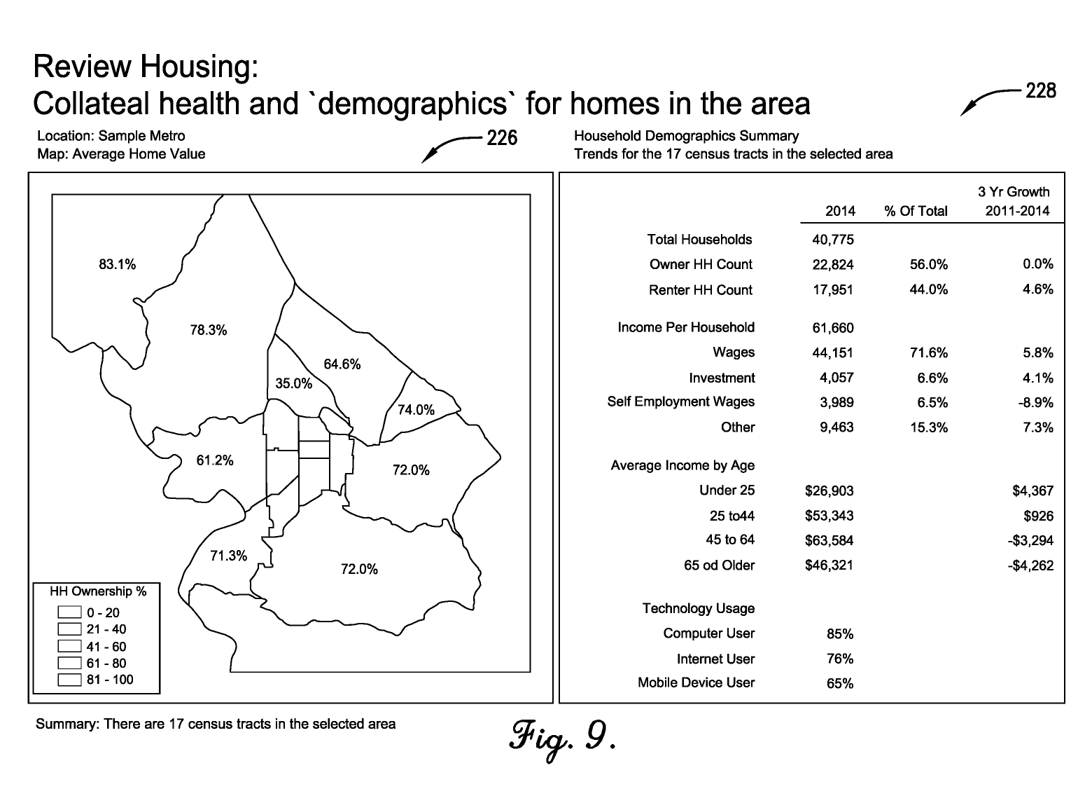

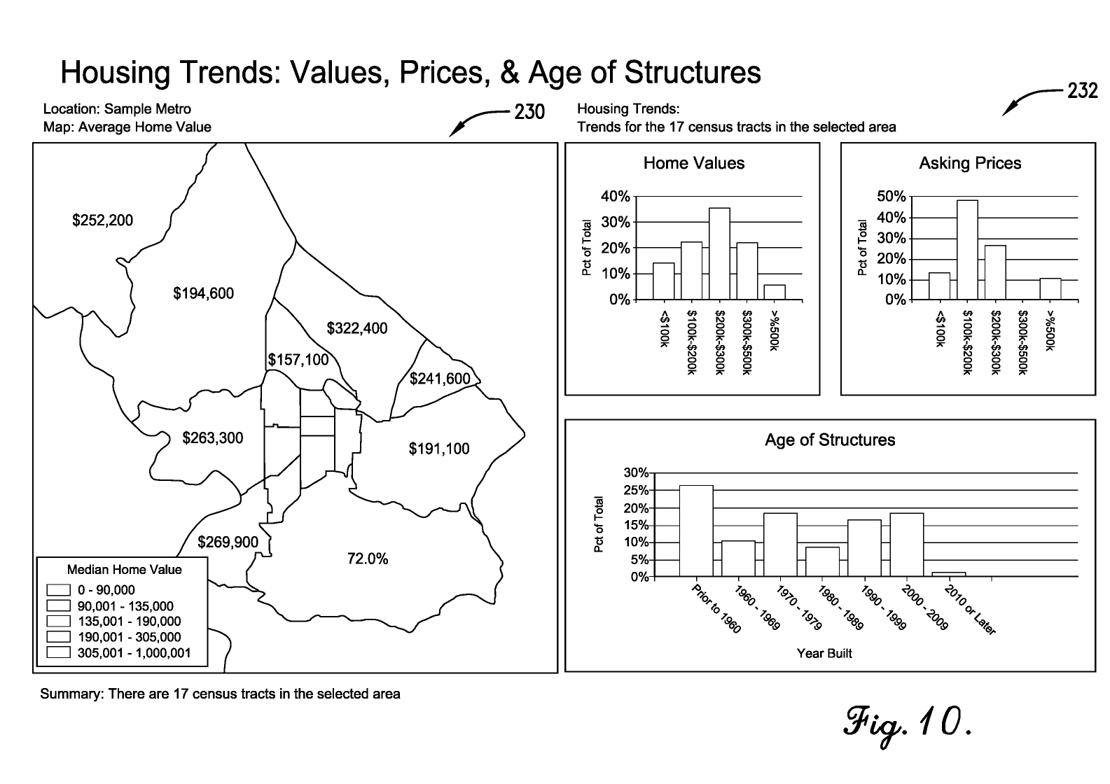

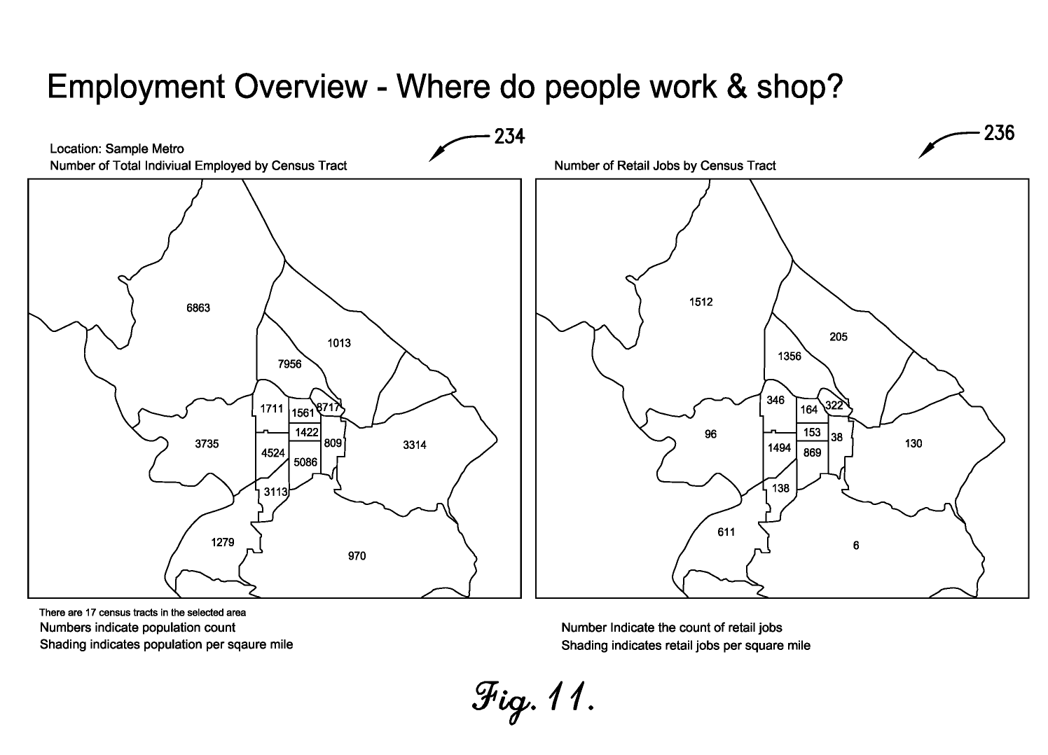

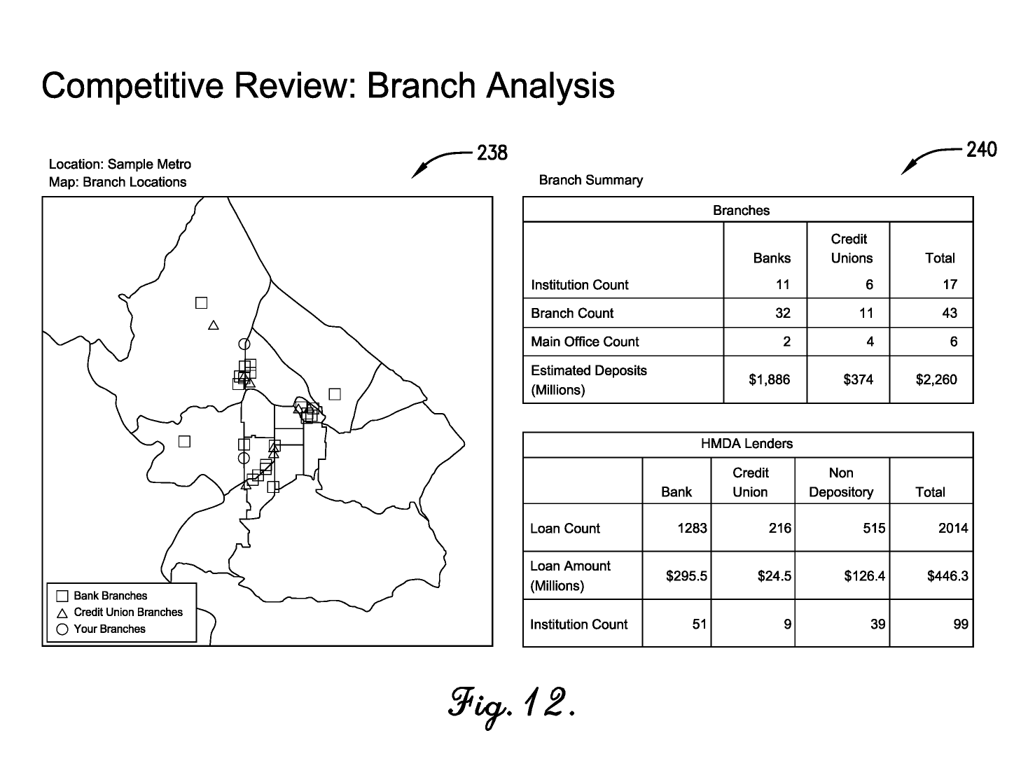

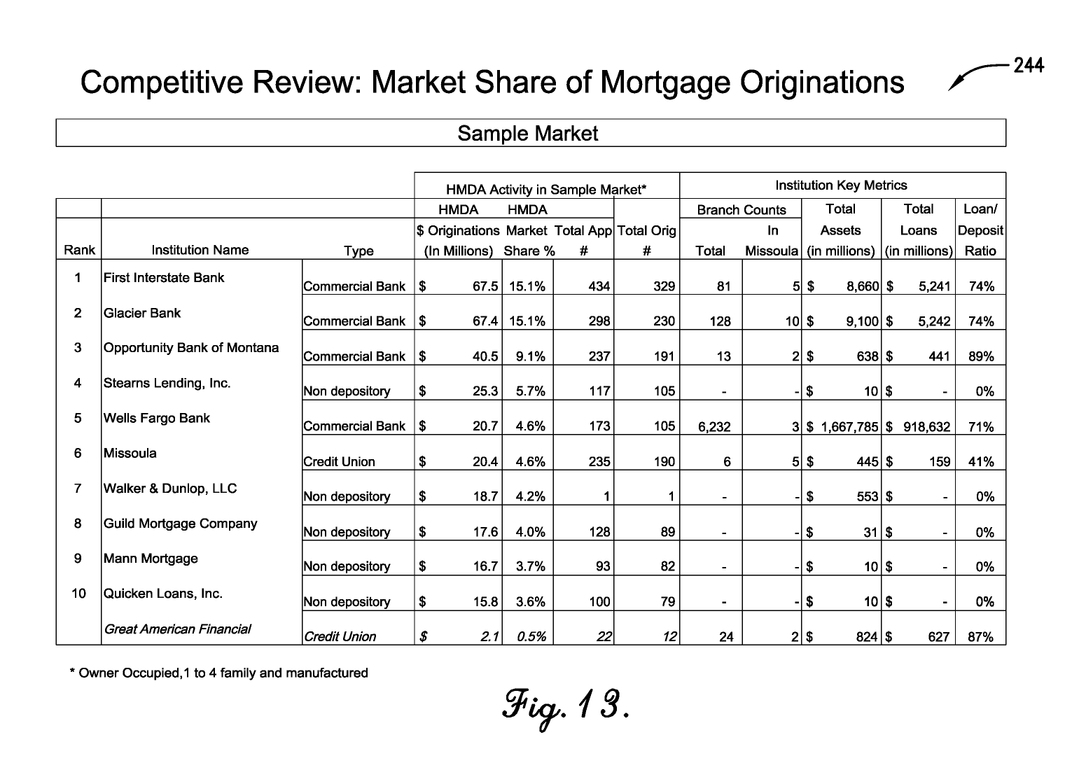

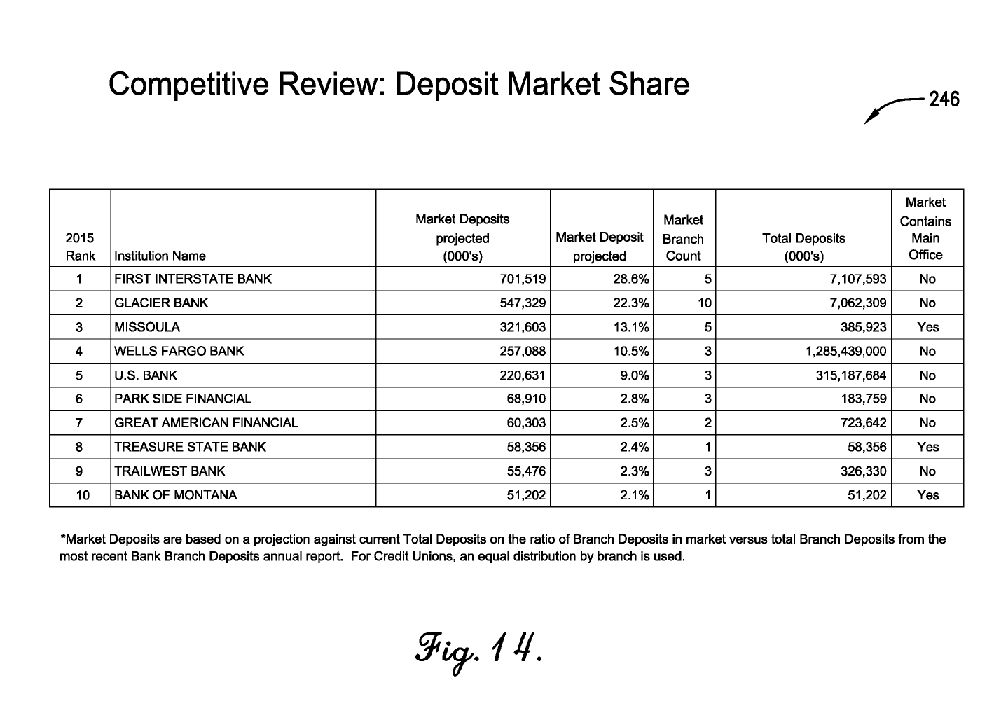

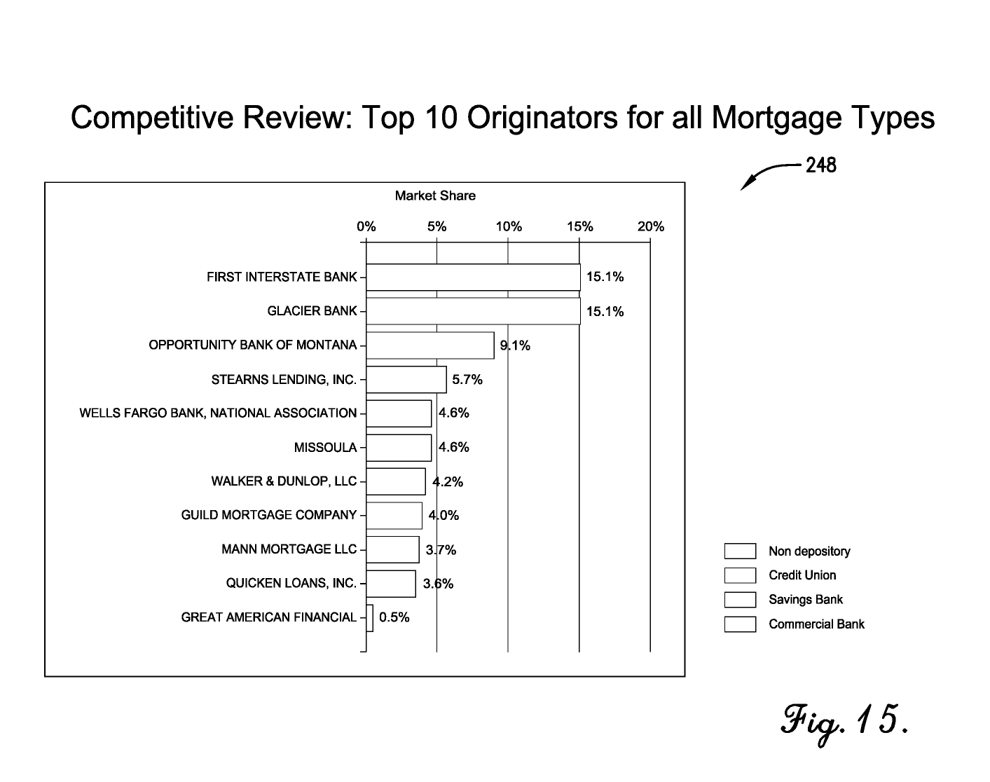

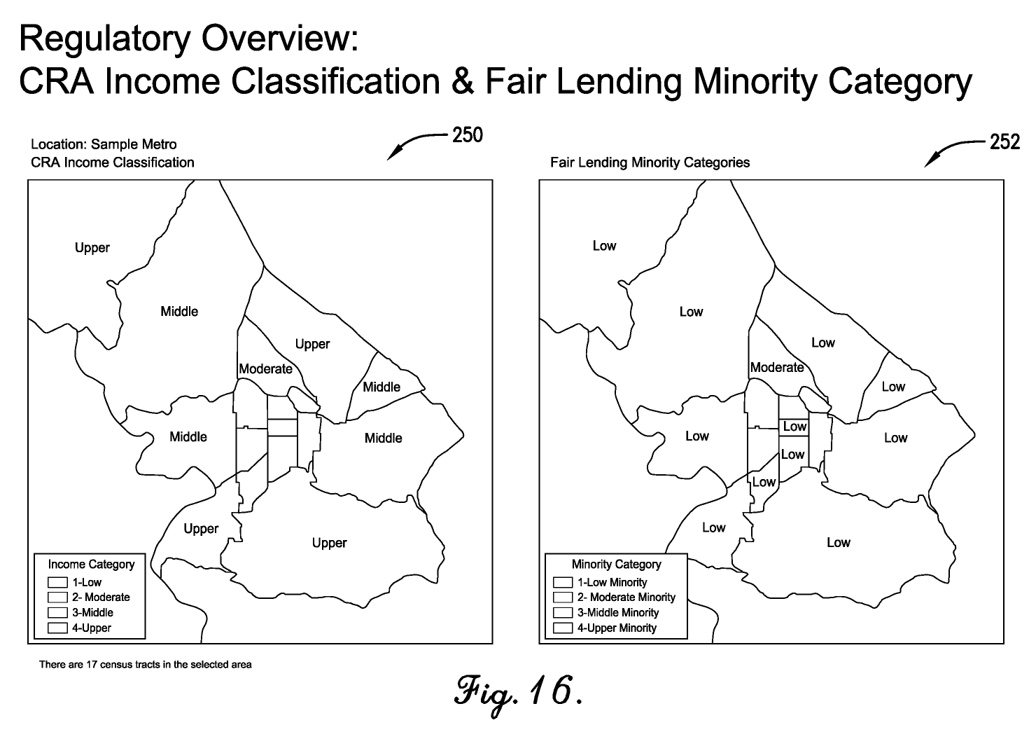

Referring also to FIGS. 4 through 16, for the purpose of illustration a portion is shown of an exemplary report substantially automatically generated by the BI application 24 for the user. FIG. 4 shows a table 212 containing a comparison of demographics across three markets, including a current market and two proposed markets. FIG. 5 shows a bulleted presentation 214 setting forth observations based on an analysis of a particular market. FIG. 6 shows a table 216 showing population trends over time for a particular market. FIG. 7 shows a map 218 and a table 220 showing a demographic summary for a particular population. FIG. 8 shows a map 222 and a table 224 describing individual moving into and home values in a particular area. FIG. 9 shows a map 226 and a table 228 describing aspects of households in a particular area. FIG. 10 shows a map 230 and a table 232 describing housing trends in a particular area. FIG. 11 shows a first map 234 showing numbers of employed for a particular area, and a second map 236 showing numbers of retail jobs for the particular area. FIG. 12 shows a map 238 showing branch locations for a particular area, a first table 240 describing the branches, and a second table 242 describing aspects of the branches. FIG. 13 shows a table 244 summarizing information for a plurality of individual institutions. FIG. 14 shows a table 246 summarizing information for a plurality of individual institutions. FIG. 15 shows a chart 248 describing market shares for a plurality of individual institutions. FIG. 16 shows a first map 250 showing income information for a particular area for regulatory purposes, and a second map 252 showing minority information for a particular area for regulatory purposes.

It will be appreciated that some or all of the components or their functionalities of the BI software application component 24 may be additionally or alternatively characterized or claimed in terms of a system, a computer-implemented method, or a computer program stored on a non-transitory computer-readable medium.

Exemplary applications for and variations of embodiments may include the following. Embodiments may provide a general purpose BI reporting tool configured to report data including charts (such as bar charts and line charts), tables, maps, and other output formats. Embodiments may provide a data analysis tool configured to access to a wide range of data, on a variety of subject matters. Embodiments may provide a source of cleansed and conformed (i.e., normalized) data so that users are not required to acquire, transform, and/or process data prior to using the data for analysis purposes. Embodiments may provide a report creation tool configured to assemble and/or allow users to assemble reports including various output formats. Embodiments may provide a presentation tool configured to create or allow users to create presentations based including various output formats.

Further, embodiments may be configured as a tool for peer and competitor analysis which allows users to compare institutions to each other. Embodiments may be configured as a decision support system which provides relevant and useful information upon which decisions can be based. Embodiments may be configured as a secure delivery platform for users to receive custom files created and uploaded for the users. Still further, embodiments may be configured as a tool for financial institutions, such as banks and credit unions, to perform peer and competitor analyses, research topics and/or other institutions, verify regulatory compliance, analyse and understand markets, and gather information to assist with planning. Other embodiments may be configured to serve other institutions and/or interests, such as general business market analyses, education (e.g., student and faculty access to current and historical data for research), insurance, investments, sports, and weather.

Still further, embodiments may facilitate analysing a market area around a current branch based on such information as Population Demographics, Home Ownership, Housing Trends, Employment, Deposit Market Share, Mortgage Market Share, etc. Embodiments may facilitate analysing a business' current market, including reviewing the overall market, the market area around existing branches, and the areas within the market where the business has no branch presence. Such analysis may help to understand the forces and trends that may be hindering growth, assess current branch infrastructure to find expensive branch overlap, and find gaps in market coverage resulting in lost business opportunities. Embodiments may facilitate analysing a business' expansion into a potential new market. Such analysis may help to understand the demographic profile of the market, identify relevant economic and demographic trends, compare the potential new markets to existing locations.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for improving access to and usefulness of data for business intelligence by a remote user of a business intelligence software application in a particular industry, the system comprising:
an electronic processing element implementing a data transporter component configured to assemble data relevant to the particular industry from a plurality of different data sources and to normalize the data; and
an electronic memory element housing a data mart component configured to receive and store the normalized data from the data transporter component, with the data mart having a plurality of data stores including a raw data store, a staged data store, a curated data store, and a metadata store,
the electronic processing element further implementing an application programming interface component configured to—
receive a request from the remote user for a high level time series and/or geospatial dataset with attributes indicating a level of aggregation and a level of granularity,
interact with the metadata store to generate a corresponding structured query language query, and
execute the structured query language query against the curated data store, and communicate the resulting dataset to the business intelligence software application in an open standard data format.

2. The system as set forth in claim 1, wherein the particular industry is a financial services industry, and the data includes demographics data, economic data, financial services data, and geographic data, and the data mart component supports times series analysis and geospatial analysis of the data.

3. The system as set forth in claim 1, wherein the data transporter component is an extraction, transformation, and loading transporter.

4. The system as set forth in claim 1, wherein the data transporter component is configured to normalize the data by performing a series of transformation, validation, and cleansing procedures in order to homogenize semantics, constraints, formats, and coding of the data from the plurality of different data sources.

5. The system as set forth in claim 1, wherein the data mart component includes multiple dimensions and hosts the curated data in a star schema having a plurality of dimensions.

6. The system as set forth in claim 5, wherein the data transporter component is configured to validate and geocode address data in order to support a geography dimension.

7. The system as set forth in claim 5, wherein the data transporter component includes a key management controller configured to submit a unique internal key for each dimension of the plurality of dimensions.

8. The system as set forth in claim 1, wherein the metadata store includes declarations of all of a plurality of data mart objects, data mart object relationships, and data mart object properties, and a set of taxonomy and inventory details, including storage locations, of curated data in the curated data store.

9. The system as set forth in claim 8, wherein the data transporter component is configured to interact with the metadata store to identify a plurality of specific objects in each data store of the plurality of data stores, and to identify a status information specific to the assembly of the data.

10. The system as set forth in claim 1, wherein the application programming interface component is further configured to provide an open standard data access via web service endpoints to the curated data store for the business intelligence software application.

11. A system for improving access to and usefulness of data for business intelligence by a remote user of a business intelligence software application in a particular industry, the system comprising:
an electronic processing element implementing an extraction, transformation, and loading data transporter component configured to assemble data relevant to the particular industry from a plurality of different data sources and to normalize the data by performing a series of transformation, validation, and cleansing procedures in order to homogenize semantics, constraints, formats, and coding of the data from the plurality of different data sources; and
an electronic memory element housing a data mart component configured to receive and store the normalized data from the data transporter component, with the data mart having a plurality of data stores including a raw data store, a staged data store, a curated data store, and a metadata store, wherein the data mart component includes multiple dimensions and hosts the curated data in a star schema having a plurality of dimensions, and wherein the data transporter component includes a key management controller configured to submit a unique internal key for each dimension of the plurality of dimensions,
the electronic processing element further implementing an application programming interface component configured to—
receive a request from the remote user for a high level time series and/or geospatial dataset with attributes indicating a level of aggregation and a level of granularity,
interact with the metadata store to generate a corresponding structured query language query, and
execute the structured query language query against the curated data store, and communicate the resulting dataset to the business intelligence software application in an open standard data format.

12. The system as set forth in claim 11, wherein the particular industry is a financial services industry, and the data includes demographics data, economic data, financial services data, and geographic data, and the data mart component supports times series analysis and geospatial analysis of the data.

13. The system as set forth in claim 11, wherein the data transporter component is configured to validate and geocode address data in order to support a geography dimension.

14. The system as set forth in claim 1, wherein the metadata store includes declarations of all of a plurality of data mart objects, data mart object relationships, and data mart object properties, and a set of taxonomy and inventory details, including storage locations, of curated data in the curated data store.

15. The system as set forth in claim 14, wherein the data transporter component is configured to interact with the metadata store to identify a plurality of specific objects in each data store of the plurality of data stores, and to identify a status information specific to the assembly of the data.

16. The system as set forth in claim 11, wherein the application programming interface component is further configured to provide an open standard data access via web service endpoints to the curated data store for the business intelligence software application.

17. A system for improving access to and usefulness of data for business intelligence by a remote user of a business intelligence software application in a particular industry, the system comprising:
an electronic processing implementing an extraction, transformation, and loading data transporter component configured to assemble data relevant to the particular industry from a plurality of different data sources and to normalize the data by performing a series of transformation, validation, and cleansing procedures in order to homogenize semantics, constraints, formats, and coding of the data from the plurality of different data sources; and
an electronic memory element housing a data mart component configured to receive and store the normalized data from the data transporter component, with the data mart having a plurality of data stores including a raw data store, a staged data store, a curated data store, and a metadata store, wherein the data mart component includes multiple dimensions and hosts the curated data in a star schema having a plurality of dimensions, and wherein the data transporter component includes a key management controller configured to submit a unique internal key for each dimension of the plurality of dimensions,
wherein the metadata store includes declarations of all of a plurality of data mart objects, data mart object relationships, and data mart object properties, and a set of taxonomy and inventory details, including storage locations, of curated data in the curated data store, and wherein the data transporter component is configured to interact with the metadata store to identify a plurality of specific objects in each data store of the plurality of data stores, and to identify a status information specific to the assembly of the data,
the electronic processing element further implementing an application programming interface component configured to—
receive a request from the remote user for a high level time series and/or geospatial dataset with attributes indicating a level of aggregation and a level of granularity,
interact with the metadata store to generate a corresponding structured query language query, and
execute the structured query language query against the curated data store, and communicate the resulting dataset to the business intelligence software application in an open standard data format.

18. The system as set forth in claim 17, wherein the particular industry is a financial services industry, and the data includes demographics data, economic data, financial services data, and geographic data, and the data mart component supports times series analysis and geospatial analysis of the data.

19. The system as set forth in claim 17, wherein the data transporter component is configured to validate and geocode address data in order to support a geography dimension.

20. The system as set forth in claim 17, wherein the application programming interface component is further configured to provide an open standard data access via web service endpoints to the curated data store for the business intelligence software application.
